(19) United States
(12) Patent Application Publication
(10) Pub. No.: US 2006/0088188 A1
(43) Pub. Date: Apr. 27, 2006

(54) Method for the detection of an obstacle

(76) Inventors: Alexander Ioffe, Bonn (DE); Su-Birm Park, Aldenhoven (DE); Guanglin Ma, Essen (DE)

Correspondence Address: DELPHI TECHNOLOGIES, INC., M/C 480-410-202, PO BOX 5052, TROY, MI, 48007, US

(21) Appl. No.: 11/247,031

(22) Filed: Oct. 10, 2005

(30) Foreign Application Priority Data
Oct. 11, 2004 (GB) 0422504.1
Jun. 1, 2005 (EP) 05011836.3

(51) Int. Cl. G06K 9/00; H04N 7/18; B60Q 1/00

(52) U.S. Cl. 382/103; 382/106; 348/135; 340/435

(57) ABSTRACT

The invention concerns a method for the detection of an obstacle located in a path of a motor vehicle, in particular a person, in which by means of a camera a first image and, with a time interval from the latter, a second image of the environment of the vehicle located in the direction of travel, are recorded, a first transformed image is generated by projection of the first recorded image out of the camera image plane into the plane of the ground, and a second transformed image is generated by projection of the second recorded image out of the camera image plane into the plane of the ground, a differential image is determined from the first and second transformed images, and by evaluation of the differential image it is determined whether an obstacle is located in the path of the vehicle.

### TECHNICAL FIELD

The invention concerns a method for the detection of an obstacle located in a path of a motor vehicle, in particular a person.

### BACKGROUND OF THE INVENTION

A method of this kind is basically known and is, for example, used to increase the safety of pedestrians in road traffic. Thus, an airbag of the motor vehicle can be released or some other suitable safety measure can be adopted as soon as a collision of the vehicle with a pedestrian takes place or is imminent.

The detection of obstacles by means of sensors, e.g. acceleration sensors and/or contact sensors, which are arranged in the region of a bumper of a motor vehicle, is known. Sensors of this kind, however, allow detection of obstacles only when they are in the immediate vicinity of the vehicle, or contact, i.e. a collision, has already taken place. Also universally known is the use of cameras in motor vehicles, for example, to reproduce the environment of the vehicle on a display which can be seen by the driver of the vehicle, as a parking aid.

When using cameras, however, basically the quantity of image data to be processed and the automatic evaluation of the images generated prove to be problematic. This is all the more so if evaluation of the image material has to take place not only automatically, but also particularly quickly, such as is necessary, for example, in a vehicle safety system, for the protection of persons in case of a collision with the vehicle.

### SUMMARY OF THE INVENTION

It is the object of the invention to provide a method which in a simple manner allows early and rapid detection of an obstacle located in a path of a motor vehicle, in particular a person.

To achieve the object, a method with the characteristics of claim 1 is provided.

With the method according to the invention for the detection of an obstacle located in a path of a motor vehicle, in particular a person, by means of a camera a first image and, with a time interval from the latter, a second image of the environment of the vehicle located in the direction of travel, are recorded. By projection of the respective recorded image out of the camera image plane into the plane of the ground, a first transformed image is generated from the first recorded image, and a second transformed image is generated from the second recorded image. From the first and second transformed images is then determined a differential image which is evaluated for whether an obstacle is located in the path of the vehicle.

The determination of obstacles with the aid of differential images allows the processing and evaluation of images which have no spatial information. This allows the recording of images with a mono camera which, compared with, for example, a stereo camera with the same image size and resolution, generates substantially smaller quantities of data. The images of a mono camera can therefore not only be evaluated particularly quickly, but they also require a lower computing power.

According to the invention, the differential image is determined not directly from the images recorded by the camera, which are hereinafter also referred to as the original images, but from transformed images. The transformed images are in this case generated by projection of the image objects out of the image plane of the original images into the plane of the ground.

By projection of the images recorded by the camera onto the ground, a rectangular image format becomes a trapezoidal image format, wherein the short parallel side of the trapezium defines the image region close to the vehicle, and the long parallel side of the trapezium defines the image region remote from the vehicle.

Image transformation leads to correct, i.e. substantially distortion-free, reproduction of the ground in the transformed image, whereas image objects, for example, human beings, which in reality stand out from the ground and extend e.g. perpendicularly thereto, are distorted in the transformed image and in particular shown in a wedge shape.

Due to selective distortion of image objects which cannot be assigned to the ground, image objects which come into question as a possible obstacle for the vehicle can be particularly easily distinguished from those which are not relevant to safety. This allows particularly reliable detection of obstacles, in particular pedestrians.

In evaluation of the differential image determined from two images with a time interval between them, use is made of the effect that the reproduction of an object which is closer to the vehicle changes more when the vehicle is moving and in particular quickly becomes larger than an object which is further away from the vehicle. In this way an object located in the foreground of the image can differ from, for example, an object located in the background of the image, and if occasion arises be identified as an obstacle.

Advantageous embodiments of the invention can be found in the subsidiary claims, the description and the drawings.

According to an advantageous embodiment, the vehicle movement, in particular the vehicle speed and/or a change of direction of travel, is taken into consideration in generation of the transformed images. In this way allowance is made for a change of camera viewing direction during a movement of the vehicle. This leads to better comparable transformed images, as a result of which ultimately the reliability of correct detection of an obstacle is increased.

Preferably the vehicle movement, in particular the vehicle speed and/or a change of direction of travel, and the time interval with which the images were recorded, are taken into consideration in determination of the differential image. This allows correct positioning of transformed images with a time interval relative to each other and hence optimum comparison of the transformed images.

As a result, the differential image exhibits maximum contrast between not substantially changing image objects, e.g. a road section located in the direction of travel, and image objects rapidly increasing in size. The transformed image of an object which in reality extends above the ground can thus be distinguished from the background even better. As a result, even more reliable detection of obstacles is possible.

Advantageously, in each case the first or second transformed image is displaced and/or rotated relative to the second or first transformed image according to the vehicle movement and the time interval with which the associated original images were recorded, in order to bring respectively identical details of the vehicle environment into register. This ensures that, in determination of the differential image, the difference in grey scale values of those picture elements which correspond to at least approximately identical locations of the vehicle environment is formed.

Picture elements of those objects which have not changed substantially from the first transformed image to the second transformed image, e.g. the image of a road, are therefore eliminated in formation of the difference, and in the differential image yield a grey scale value of at least approximately zero. Only the picture elements of those objects which are located in the more immediate vehicle environment and which extend above the ground and are therefore distorted in the transformed images and in particular shown in a wedge shape, cannot be brought into register when the vehicle is moving towards the object. As the image of the object becomes larger and larger as the vehicle approaches, at least the picture elements forming the edge region of the object in the differential image exhibit a grey scale value clearly differing from zero. As a result, an object extending above the ground can be distinguished from the background with even greater safety and an obstacle can be determined even more reliably.

Preferably, a particularly wedge-shaped object of the differential image is classed as an obstacle. As already mentioned, an object of the differential image is an object of which the picture elements have not been eliminated in formation of the difference. The transformed image of such an object must therefore change from one transformed image to the next, in particular increase in size. This is precisely so when this involves the reproduction of an object located in the more immediate vehicle environment and extending above the ground. If this object is located in the path of the vehicle, it must be regarded as an obstacle for the vehicle.

An object of the differential image classed as an obstacle can be transformed back into the recorded images. This makes it possible to mark an object classed as an obstacle as such in the recorded images too, for example, by suitable colouring or framing.

Advantageously, the camera is oriented in such a way that the skyline runs through the recorded images. An object located close enough to the vehicle and/or extending high enough above the ground will thus always intersect with the skyline in the recorded images. Crossing the skyline can consequently be used as an additional criterion in classing a detected object as an obstacle.

It is particularly preferred if only the region of a recorded image which, starting from the skyline, is located below the skyline, is projected onto the ground. Projection of the recorded image region above the skyline, e.g. of the sky, onto the ground is, in other words, excluded. The transformed image thus includes only the region of the reproduced vehicle environment located below the skyline. In this way the quantity of image data to be processed is considerably reduced. This allows the method to be carried out with a lower computing power and/or accelerated processing of the recorded images, i.e. faster detection of obstacles.

According to a further advantageous embodiment, the differential image is evaluated, starting from an edge of the differential image which is located in the region of the skyline. First, therefore, it is checked whether the differential image includes an object which is located in the region of the skyline, i.e. in the original images intersects with the skyline. Only such an object is considered at all as an obstacle for the vehicle.

If the evaluation in the edge region of the differential image delivers no result, i.e. no picture elements with grey scale values clearly differing from zero, then further evaluation of the differential image is refrained from. Complete evaluation of the differential image takes place possibly when an object is already detected in the edge region of the differential image. In this way superfluous evaluation of object-free differential images is avoided. This allows the method to be carried out even faster, or requires an even lower computing power.

Preferably, on detection of an object in the region of the skyline, further evaluation of the differential image is limited to the region of the object. The differential image is, in other words, not completely evaluated even when an object is detected in the edge region of the differential image. Rather, evaluation of the differential image takes place selectively, namely deliberately in the image region in which the object extends. Superfluous evaluation of object-free image regions of the differential image is thus avoided. The efficiency of image evaluation is hence still further increased, so that even faster detection of an obstacle is possible or an even lower computing power is required.

According to a further embodiment, image noise of the differential image is minimised by taking into consideration an actual tilt of the camera relative to the ground. In this way, accidental tilting of the camera which can occur for example when driving on uneven ground is levelled out. By minimising the image noise, the contrast of the differential image is still further increased, so that an object to be classed as an obstacle can be detected even more reliably.

Preferably, the actual camera tilt is determined from the differential image. Basically, the camera tilt present at any given time can also be detected by means of suitable sensors, e.g. acceleration sensors. Compared with this, computer detection of the camera tilt from the differential image can, however, be carried out quickly.

Advantageously, the sum of grey scale values of the pixels of the differential image along an imaginary line starting from the vehicle and not running through a detected object is formed, and minimised by variation of the underlying camera tilt. In an object-free region of the differential image, to a certain extent one-dimensional variance analysis of the camera tilt is therefore carried out.

In the process, the camera tilt which leads to a minimum sum of grey scale values can be regarded as the actual camera tilt.

Advantageously, the differential image is determined anew, taking into consideration the actual camera tilt, and/or a subsequent differential image is determined, taking into consideration the actual camera tilt. After determining the actual camera tilt, the differential image with the aid of which the actual camera tilt was determined can therefore be corrected to generate a lower-noise differential image. Alternatively or in addition, the actual camera tilt can be used as a basis for determining subsequent differential images until an actual camera tilt which is again changed is determined.

A further subject of the invention is a device for the detection of an obstacle located in a path of a motor vehicle, in particular a person, with the characteristics of claim 17.

By means of the device, the method according to the invention can be carried out, and the above-mentioned advantages can be obtained.

### BRIEF DESCRIPTION OF THE DRAWINGS

Below, the invention is described purely by way of example with the aid of an advantageous embodiment, with reference to the drawings, in which:

FIG. 1 is the beam path in the reproduction of a road section on an image plane of a camera of a device according to the invention;

FIG. 2 is the transformation of a recorded image into a transformed image;

FIG. 3 is the beam path of reproduction of an obstacle on the image plane of a camera of a device according to the invention at two different times;

FIG. 4 is two transformed images with a time interval between them while a motor vehicle is moving; and

FIG. 5 is a transformed image with an object to be classed as an obstacle.

### DESCRIPTION OF THE PREFERRED EMBODIMENT

With the method according to the invention for the detection of an obstacle 12 located in a path of a motor vehicle 10, by means of a camera 14 several images 16 of the environment of the vehicle 10 located in the direction of travel with a time interval between them are recorded. The camera 14 is a mono camera, for example, a mono video camera, which is arranged in a front region of the vehicle 10, for example, in the region of a rear-view mirror of the vehicle 10, and is oriented into a region of the vehicle environment located in the front of the vehicle 10. Alternatively or in addition it is also possible to provide a rearwardly oriented camera which monitors an environment region located behind the vehicle 10.

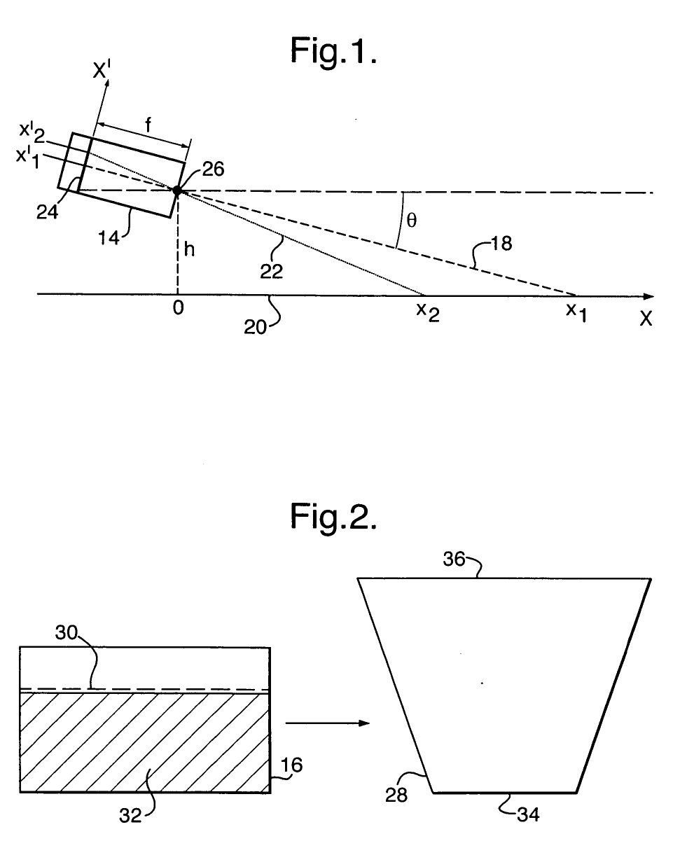

As FIG. 1 shows, the camera 14 is not oriented exactly horizontally when the vehicle 10 is stationary, but inclined downwards by an angle θ, so that the optical axis 18 of the camera 14 impinges on the ground 20 at a point x₁ located in front of the vehicle 10. As shown by the optical axis 18 and the dotted line 22, the region of the ground 20 located between x₁ and x₂ is reproduced as a region located between the points x′₁ and x′₂ on an image plane 24 of the camera 14. Point 26 denotes the focus of the camera 14, which is located at a height h above the ground 20.

In order to determine whether an obstacle is located in the path of the vehicle 10, first a transformed image 28 is generated by means of a transformation unit from each recorded image 16. Basically, it is also possible to transform only every nth recorded image 16, n being a natural number greater than 1. The frequency of transformation may furthermore be dependent on the rate at which the images 16 are recorded, or be varied as a function of e.g. the vehicle speed or the degree of the change of direction of travel.

Transformation takes place by projection of the recorded image 16 out of the image plane 24 into the plane of the ground 20. In the process, it is not the whole image 16 that is transformed, but only a region 32 which is located below the skyline 30 running through the image 16 and which is shown hatched in FIG. 2. The region of the image 16 which is located above the skyline 30 and which reproduces the sky in case of a flat landscape remains excluded from transformation.

While the recorded image 16 is substantially rectangular, transformation leads to a trapezoidal shape of the transformed image 28. Here, the shorter parallel side 34 defines the region of the transformed image 28 close to the vehicle, and the longer parallel side 36 defines the image region close to the horizon.

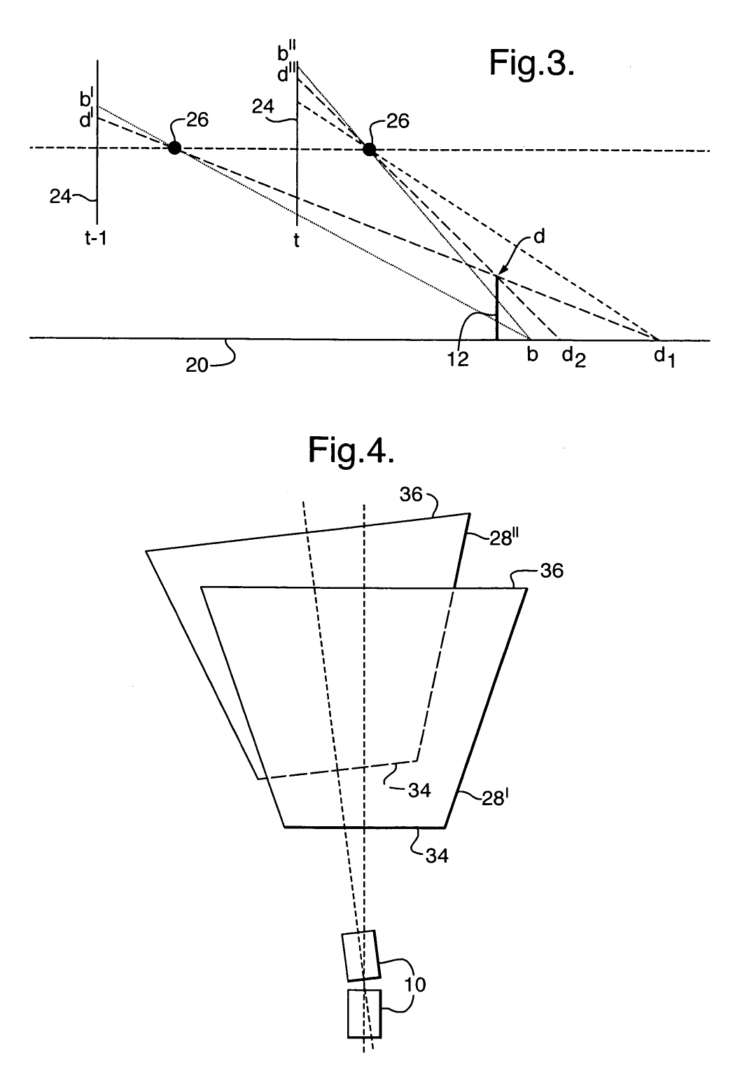

In FIG. 3, projection of the recorded image 16 out of the image plane 24 into the plane of the ground 20 is illustrated in more detail.

At a time t−1, the motor vehicle 10 is located at a certain distance from an obstacle 12. The point d of the obstacle 12 is reproduced at time t−1 on the point d′ in the image plane 24. A point b located on the ground 20 is reproduced at a point b′. To project the points b′ and d′ out of the image plane 24 into the plane of the ground 20, the straight line which runs through the point b′ or d′ and the focus 26 is extended until it intersects with the plane of the ground 20. This point of intersection denotes the respective transformed picture element b or d₁ of a first transformed image 28′.

A predetermined time interval later, namely, at time t, a further image 16 of the vehicle environment is recorded. As the vehicle 10 has got closer to the obstacle 12 in the meantime, point d of the obstacle 12 is now reproduced at point d″ of the image plane 24. Similarly, point b of the ground 20 is reproduced at point b″ of the image plane 24. Projection of the reproduced points b″ and d″ into the plane of the ground 20 results in the picture elements b and d₂ of a second transformed image 28″.

As can be seen from FIG. 3, the relative distance between point d₁ or d₂ of the obstacle 12 and point b of the ground 20 shortens from the first to the second transformed image 28, the more so, the closer the vehicle comes to the obstacle 12. With increasing proximity of the vehicle 10 to the obstacle 12, there is therefore a change in shape of the obstacle 12 in the transformed images 28, whereas the image of the ground 20 in the transformed images 28 remains substantially the same.

By comparison of the transformed images 28 of two images 16 recorded at staggered times, it can therefore be ascertained whether an obstacle 12 is located in the path of the vehicle 10 or not. Those objects which extend significantly above the ground 20 are assessed as obstacles 12 here, because only such objects change their size significantly in the transformed images 28 when the vehicle 10 approaches. This is the case with pedestrians, for example.

To compare two transformed images 28, by means of a difference-forming unit a differential image is generated from two transformed images 28′, 28″ immediately succeeding each other in time, for example. The grey scale values of the individual pixels of the differential image here correspond precisely to the difference in grey scale values of the corresponding pixels of the earlier and later transformed images 28′, 28″.

To prevent the difference being formed between two picture elements which in each case reproduce different regions of the vehicle environment, the transformed images 28′, 28″ are positioned correctly to each other. The positioning of the transformed images 28′, 28″ is here effected not only taking into consideration the time interval with which the associated images 16 were recorded, but also taking into consideration the vehicle movement, in particular the speed of the vehicle 10 and any change of direction of travel.

In FIG. 4 is shown a motor vehicle 10 which is moving forwards and in the process describes a left turn. Accordingly, a later transformed image 28″ compared with an earlier transformed image 28′ is not only offset in the direction of travel and to the left, but also rotated anticlockwise. In order that the picture elements of which the grey scale values are respectively subtracted reproduce the same regions of the vehicle environment in both transformed images 28′ and 28″, the transformed images 28′ and 28″ are brought into register by corresponding translation and rotation of the earlier and/or later transformed image 28′, 28″.

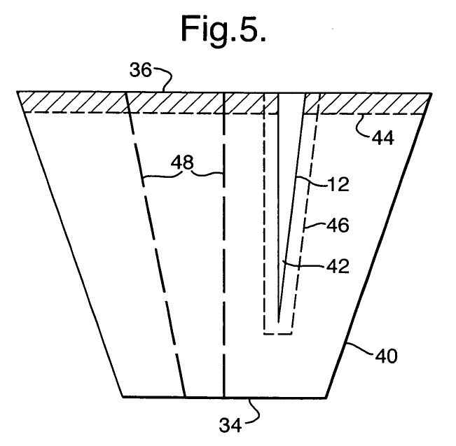

In FIG. 5 is shown a differential image 40 generated in this way. The white region of the differential image constitutes a region in which the picture elements of the transformed images 28′, 28″ have been eliminated, i.e. in which the difference in grey scale values of pixels is at least approximately zero.

The wedge-shaped dark region 42 constitutes an obstacle 12. In this region the pixels have not been eliminated, as the grey scale values of the picture elements of the transformed images 28′, 28″ in this region differed from each other considerably. The distance between the tip of the wedge-shaped region 42 and the shorter parallel side 34 of the differential image 40 indicates the distance from the obstacle 12 to the vehicle 10.

Evaluation of the differential image 40 is effected by means of an evaluation unit, starting from the longer parallel side 36 in an image region 44 close to the horizon and extending across the full width of the differential image 40, which is shown hatched in FIG. 5.

Experience has shown that certain categories of safety-relevant obstacles 12 extend so far above the ground 20 that they intersect with the skyline 30 in the recorded image 16. If such an obstacle 12 is located in the region of the environment of the vehicle 10 being monitored, it is consequently reproduced at least in the image region 44 of the differential image 40 close to the horizon. To accelerate evaluation of the differential image 40 for the detection of obstacles of this kind and minimise the computing power needed, it is therefore sufficient initially to examine the edge region 44 of the differential image close to the horizon for pixels of which the grey scale values clearly differ from zero.

If such picture elements are not detected in the edge region 44, then evaluation of the present differential image 40 is broken off.

If, on the other hand, on analysis of the edge region 44 close to the horizon, pixels of which the grey scale values clearly differ from zero are detected, then evaluation of the differential image 40 is continued. In this case, however, further analysis of the differential image 40 no longer extends over the full width of the differential image 40, but it is limited to a region 46 surrounding the wedge-shaped region 42. Evaluation of the differential image 40 is, in other words, continued only in the image region 46 in which is located the detected image of the obstacle 12. That even on detection of an obstacle 12 not the whole differential image 40 is analysed, further contributes to accelerating the image evaluation and keeping the required computing power low.

To increase the quality of image evaluation and the reliability with which an object of the differential image 40 is recognised as an obstacle 12, the image noise of the differential image 40 which results from minor changes to the angle of inclination θ of the camera 14 is minimised by taking into consideration the tilt of the camera 14 which is actually present at any given time, when generating the differential image 40.

The actual tilt of the camera 14 is here determined from the differential image 40 itself. For this purpose the sum of grey scale values of the pixels of the differential image 40 along an imaginary straight line 48 starting from the vehicle 10, not running through a detected object 42 and extending in the direction of the horizon is formed. The straight line 48 extends, in other words, from the shorter parallel side 34 to the longer parallel side 36 of the differential image 40, without intersecting with an object 42 to be classed as an obstacle 12. In FIG. 5 are shown two straight lines 48 which are both suitable in each case for determining the actual camera tilt.

After the sum of pixel grey scale values along the straight line 48 has been determined, the underlying camera tilt is varied by computer to minimise the sum of grey scale values. The camera tilt angle at which the sum of pixel grey scale values is minimal indicates the actual tilt of the camera 14 forming the basis of the present differential image 40. To a certain extent, therefore, one-dimensional variance analysis of camera tilt is carried out.

Taking into consideration the newly determined actual camera tilt, a corrected differential image 40 which has reduced image noise compared with the original differential image 40 can be generated. On account of the suppressed image noise, even those objects of the differential image 40 of which the pixel grey scale values did not go beyond the increased noise can still be detected too. By reduction of the image noise, the quality of image evaluation and hence the reliability of detection of an obstacle is therefore still further increased.

List of Reference Numbers

10 motor vehicle
12 obstacle
14 camera
16 recorded image
18 optical axis
20 ground
22 line
24 image plane
26 focus
28 transformed image
30 skyline
32 region
34 parallel side
36 parallel side
40 differential image
42 wedge-shaped region
44 edge region
46 region
48 straight line

1. Method for the detection of an obstacle (12) located in a path of a motor vehicle (10), in particular a person, in which
by means of a camera (14) a first image (16) and, with a time interval from the latter, a second image (16) of the environment of the vehicle (10) located in the direction of travel, are recorded,
a first transformed image (28) is generated by projection of the first recorded image (16) out of the camera image plane (24) into the plane of the ground (20), and a second transformed image (28) is generated by projection of the second recorded image (16) out of the camera image plane (24) into the plane of the ground (20),
a differential image (40) is determined from the first and second transformed images (28), and
by evaluation of the differential image (40) it is determined whether an obstacle (12) is located in the path of the vehicle (10).

2. Method according to claim 1, characterised in that the images (16) are recorded by means of a mono camera (14).

3. Method according to any of the preceding claims, characterised in that the vehicle movement, in particular the vehicle speed and/or a change of direction of travel, is taken into consideration in generation of the transformed images (28).

4. Method according to any of the preceding claims, characterised in that the vehicle movement, in particular the vehicle speed and/or a change of direction of travel, and the time interval with which the images (16) were recorded, are taken into consideration in determination of the differential image (40).

5. Method according to any of the preceding claims, characterised in that the first or second transformed image (28) is displaced and/or rotated relative to the second or first transformed image (28) according to the vehicle movement and the time interval with which the associated images (16) were recorded, in order to bring respectively identical details of the vehicle environment into register.

6. Method according to any of the preceding claims, characterised in that a particularly wedge-shaped object (42) of the differential image (40) is classed as an obstacle (12).

7. Method according to any of the preceding claims, characterised in that an object (42) of the differential image (40) classed as an obstacle (12) is transformed back into the recorded images (16).

8. Method according to any of the preceding claims, characterised in that the camera (14) is oriented in such a way that the skyline (30) runs through the recorded images (16).

9. Method according to claim 8, characterised in that only the region (32) of a recorded image (16) which, starting from the skyline (30), is located below the skyline (30), is projected onto the ground (20).

10. Method according to claim 8 or 9, characterised in that the differential image (40) is evaluated, starting from an edge (36) of the differential image (40) which is located in the region of the skyline (30).

11. Method according to claim 10, characterised in that, on detection of an object (42) in the region of the skyline (30), further evaluation of the differential image (40) is limited to the region (46) of the object (42).

12. Method according to any of the preceding claims, characterised in that image noise of the differential image (40) is minimised by taking into consideration an actual tilt of the camera (14) relative to the ground (20).

13. Method according to claim 12, characterised in that the actual camera tilt is determined from the differential image (40).

14. Method according to claim 12 or 13, characterised in that the sum of grey scale values of the pixels of the differential image (40) along an imaginary line (12) starting from the vehicle (10) and not running through a detected object (42) is formed, and minimised by variation of the underlying camera tilt.

15. Method according to claim 14, characterised in that the camera tilt which leads to a minimum sum of grey scale values is regarded as the actual camera tilt.

16. Method according to any of claims 12 to 15, characterised in that the differential image (40) is determined anew, taking into consideration the actual camera tilt, and/or a subsequent differential image (40) is determined, taking into consideration the actual camera tilt.

17. Device for the detection of an obstacle (12) located in a path of a motor vehicle (10), in particular a person, with
a camera (14) for recording a first image (16) and, with a time interval from the latter, a second image (16) of the environment of the vehicle (10) located in the direction of travel,
a transformation unit for generating a first transformed image (28) by projection of the first image (16) out of the camera image plane (24) into the plane of the ground (20), and a second transformed image (28) by projection of the second image (16) out of the camera image plane (24) into the plane of the ground (20),
a difference-forming unit for determining a differential image (40) from the first and second transformed images (28), and
an evaluation unit for evaluation of the differential image (40) for whether an obstacle is located in the path of the vehicle.
